(19) United States
(12) Patent Application Publication
(10) Pub. No.: US 2002/0113870 A1
(43) Pub. Date: Aug. 22, 2002

(54) Pipeline televising apparatus with wireless remote controller

(76) Inventors: Gareth J. Mueckl, Milwaukee, WI (US); David G. Janu, Brookfield, WI (US)

Correspondence Address: Peter N. Jansson, Jansson, Shupe & Munger, Ltd., 245 Main Street, Racine, WI, 53403, US

(21) Appl. No.: 09/785,678

(22) Filed: Feb. 16, 2001

(51) Int. Cl. H04N 7/18

(52) U.S. Cl. 348/84; 348/85

(57) ABSTRACT

One embodiment, which might be termed a retrofit kit, involves apparatus for controlling pipeline televising equipment comprising a power control unit having at least one input plug. The apparatus includes a communication module having a receiving antenna and an output plug substantially identical to the input plug. The apparatus also includes a wireless handheld master control module having a transmitting antenna. The control module includes at least two actuators, one each for panning and for tilting a pipeline television camera. Another embodiment comprises a substantially complete pipeline televising system. Such system includes a power control module having (a) a power control unit, (b) a digital display unit, (c) a video cassette recorder, and (d) a television monitor. The system also has a pipeline televising camera cable-tethered to the power control unit through a power line modem. In the improvement, the power control module includes a communication section having a receiving antenna and the system also has a wireless handheld master control module having a transmitting antenna. The wireless master control module affords an operator a high degree of mobility and often permits pipeline televising to be performed by one person.

### FIELD OF THE INVENTION

This invention relates generally to television and, more particularly, to special-purpose televising apparatus for inspecting pipelines.

### BACKGROUND OF THE INVENTION

Pipelines are used to move a wide variety of useful products or waste from place to place. Examples include pipelines carrying natural gas, oil, gasoline, other chemical products or sewage. Pipelines are inspected after installation and before being placed into use or, frequently, are inspected when some defect is suspected. Examples of defects include obstructions, faulty joints or cracks, the latter two permitting the product to leak out of the line.

In many pipelines, it is impractical or impossible for a worker to directly view the pipeline interior. The pipeline may have carried a product hazardous to humans or such pipeline may simply be of such a diameter, e.g., 6 inches, that human entry is impossible.

For such inspections, a pipeline televising system is used. A typical system includes a reel on which is wound a length of multi-conductor electrical cable. Reels holding 1000 feet or more of cable are common. That end of the cable which goes “down the hole” is electrically and mechanically connected to a transporter (sometimes referred to as a “tractor”) sized to fit easily within the pipeline to be inspected. An example of such a tractor is the TRAX transporter made by U-Tech Environmental Manufacturing Supply, Inc. (UEMSI), of Menomonee Falls, Wis., a leading manufacturer of pipeline televising systems and the assignee of the invention. Such a tractor has an electrically-powered propulsion system configured to tractively engage the interior surface of the pipeline and move the tractor therealong, pulling the cable behind it..

Mounted to the tractor (and also connected to the cable) is a tube-like televising camera such as the exemplary UEMSI Explorer pan and tilt camera. (Such a camera is so named because its electrically-controlled head is capable of “panning” from side to side or tilting up and down so that the entire pipeline interior surface may be brought into view on an above-ground television monitor.) Both the tractor and the camera are controlled by electrical signals applied to the aforementioned electrical cable.

The above-ground end of the cable is electrically and mechanically connected to a power control unit which (typically) has incorporated therein a digital display unit, a television monitor and a video cassette recorder. Optionally, a personal computer (PC) may be connected to the digital display unit and to the video cassette recorder to create commands for moving the transporter and/or the camera head.

In one typical arrangement the power control unit, digital display unit, television monitor, video cassette recorder (VCR) and optional PC are mounted in an enclosed truck for transporting the system from site to site. Such truck also carries the reel, tractor, camera and other ancillary equipment needed to perform pipeline inspections. The control unit, display unit, monitor and VCR may also be carried by, for example, an all-terrain vehicle (ATV). Aspects of pipeline televising systems are disclosed in U.S. Pat. No. 4,913,558 (Wettervik et al.), U.S. Pat. No. 5,090,259 (Shishidu et al.), U.S. Pat. No. 5,142,989 (Suzumori et al.) and U.S. Pat. No. 5,195,392 (Moore et al.).

When the aforedescribed mobile system is set up for pipeline inspection, a worker lowers the tractor and camera into an opening, e.g., a manhole, while an operator sits in the truck and operates the power control unit to energize the tractor and move it and the camera into the line to be televised. Such operator views the pipeline interior as it appears on the television monitor and, often, makes a video tape of the images provided by the camera. The reel is equipped with a shaft encoder which provides signals to the digital display unit representing the distance the tractor/camera has traversed inside the pipeline. In that way, if a defect is found, the worker and operator know the precise position of the camera and, therefore, of the defect.

While the aforedescribed arrangement (and other, similar arrangements) have been generally satisfactory for the intended purpose, there are disadvantages. Using such an arrangement, pipeline inspection usually requires two persons, one at the pipeline entry point to handle the cable, tractor and camera and another at the truck to operate the electrical equipment. Such persons find it useful to communicate with one another but under certain terrain conditions, the truck must be located some distance from the pipeline entry point. Voice communication is difficult.

In an effort to give the person operating the electrical equipment greater latitude in positioning himself or herself, some manufacturers of pipeline televising systems provide a hand-held control device tethered to the power control unit with a coiled cord. An example of such a system is disclosed in U.S. Pat. No. 5,090,259 (Shishidu et al.). In a few situations (where the truck or at least the electrical equipment can be brought very close to the point of pipeline entry), it may be possible for a single person to both manipulate the cable and tractor-bearing camera and to operate the power control unit and view the television display. That is, the tethered remote control device permits the operator of the electrical equipment to alight from the truck. However, s/he cannot venture far from it.

A further improvement in pipeline televising systems which would allow the electrical equipment operator greater flexibility of location and, in many instances, permit all components of the system to be operated by a single person would be a significant advance in the art.

### OBJECTS OF THE INVENTION

It is an object of the invention to provide pipeline televising apparatus overcoming some of the problems and shortcomings of the prior art.

Another object of the invention is to provide pipeline televising apparatus which provides an operator greater latitude of movement during operation.

Another object of the invention is to provide pipeline televising apparatus operable by one person.

Still another object of the invention is to provide pipeline televising apparatus which frees an operator from the restraints of a cord-connected remote control. How these and other objects are accomplished will become apparent from the following descriptions and from the drawings.

### SUMMARY OF THE INVENTION

An aspect of the invention involves apparatus (which might be termed a retrofit kit) for controlling pipeline inspecting equipment of the type having a power control unit with at least one input plug. The apparatus has a communication module with an output plug substantially identical to the input plug so that “plug compatibility” is achieved as to number and locations of plug pins. The communication module has an antenna for receiving electromagnetic radiation (EMR) at a radio frequency. A frequency between about 10 KHz and about 6 GHz could be used. However, it is preferred that such frequency be selected to fall within one of the several “license-free” bands. Such bands are so named because so long as the transmitter power is kept below a certain level, no U.S. Federal Communication Commission (FCC) license is needed for its operation.

The apparatus also has a master control module which includes a transmitting antenna which radiates the EMR received by the communication module antenna. The master control module has at least two actuators (i.e., first and second actuators push buttons, “bat handle” actuators or the like), one each for panning and for tilting a pipeline television camera. In a more specific embodiment, the master control module also has a third actuator for energizing a tractor carrying the camera.

The master control module includes a radio-frequency (RF) transmitter coupled to the transmitting antenna. When any one of the actuators is manipulated, the transmitting antenna radiates a signal having (in preferred embodiments) a frequency in one of the license-free bands. More preferably, such frequency is between about 400 MHz and about 430 MHz and in a very specific embodiment, such frequency is 418 MHz. Most preferably, the transmitted signal is known as an on-off keyed (OOK) signal. An on-off keyed transmitter does not transmit a continuous carrier. Since the master control module is battery powered, battery life is thereby materially extended. Of course, other types of keying (e.g., frequency shift keying or FSK) could be used but at the expense or shortened battery life or a substantially heavier master control module.

In addition to the communication module and the master control module, a highly preferred apparatus also includes a televising camera. Thus, the modules and the camera can be sold as a “package” to retrofit existing systems to a wireless remote configuration.

Another aspect of the invention involves a substantially complete pipeline televising system that might be purchased by a municipality or contractor undertaking to perform pipeline televising. Such system includes a power control module having (a) a power control unit, (b) a digital display unit, (c) a video cassette recorder and (d) a television monitor. That is, the power control module is “integrated” (probably within a single housing) to include the aforementioned components. A pipeline televising camera is cable-tethered to the power control unit through a power line modem.

The power control module also includes a communication section having a receiving antenna. And the system has a master control module equipped with a transmitting antenna and a finger-operated actuator for, e.g., panning the camera. When such actuator is manipulated, a radio-frequency signal radiates from the transmitting antenna and is received by the receiving antenna. In a mobile arrangement, the antennas are likely to be separated by an opaque barrier, i.e., the truck body. When the radio frequency signal propagates from the transmitting antenna, such signal penetrates the barrier. As noted above, the radiated signal has a frequency between about 10 KHz and 6 GHz.

Yet another aspect of the invention involves a method for televising the interior of a pipeline. Such method includes the steps of providing a pipeline televising system having (a) a tractor-mounted camera, (b) a power control unit cable-coupled to the camera, and (c) a communication module electrically coupled to the power control unit and having a receiving antenna mounted thereon. The tractor-mounted camera is lowered into a pipeline and then at least one actuator on a master control module is manipulated. Such module has a transmitting antenna and such actuation causes a radio frequency signal to be transmitted from the master control module to the communication module.

In more specific aspects of the new method, the pipeline includes a manhole and the lowering step includes lowering the tractor-mounted camera downwardly through the manhole. The manipulating step is carried out adjacent to the manhole. That is, the operator can stand very near the manhole and lower the camera thereinto while keeping it in view and, simultaneously, control the tractor and/or camera, all from that vantage point. In a very specific method, the lowering and manipulating steps are carried out within 10 feet of the manhole.

Another aspect of the new method relates to an automatic tractor shutoff feature. It is assumed that the manipulating step commands the tractor to move forward inside the pipeline. It is also assumed that during the course of work, the operator moves the master control module to a location greater than a predetermined distance (e.g., 100 feet) from the communication module. When such movement occurs, the tractor is disabled. The communication module is arranged in such a way that its internal circuitry periodically (every few milliseconds) “checks” to see whether a signal is still being received from the master control module. When such modules get “out of range” of one another, the RF signal becomes so weak that the communication module interprets it as a lost signal. Tractor disabling follows. (It is to be appreciated that the maximum output power of the master control module is only a few milliwatts.)

Yet another aspect of the new method assumes there is an opaque barrier (e.g., the body of the truck used to transport the system from site to site) between the master control module and the communication module. The transmitting step includes transmitting the RF signal through the barrier. Other details of the invention are set forth in the drawings and in the detailed descriptions which follow.

### BRIEF DESCRIPTION OF THE DRAWINGS

FIG. 1 is a perspective view, partly cut away and partly in dashed outline, showing portable pipeline televising equipment, together with the operator and the environment in which such equipment is operated.

FIG. 2 is a block schematic diagram of equipment shown in FIG. 1.

FIG. 3 is a representation of the front face of an exemplary master control module.

FIG. 4 is a representation of an on-off keyed (OOK) signal.

FIG. 5 is a perspective view, partly cut away and partly in dashed outline, showing mobile pipeline televising equipment, together with the operator and the environment in which such equipment is operated.

FIG. 6 is a block schematic diagram of equipment shown in FIG. 5.

### DETAILED DESCRIPTION OF PREFERRED EMBODIMENTS

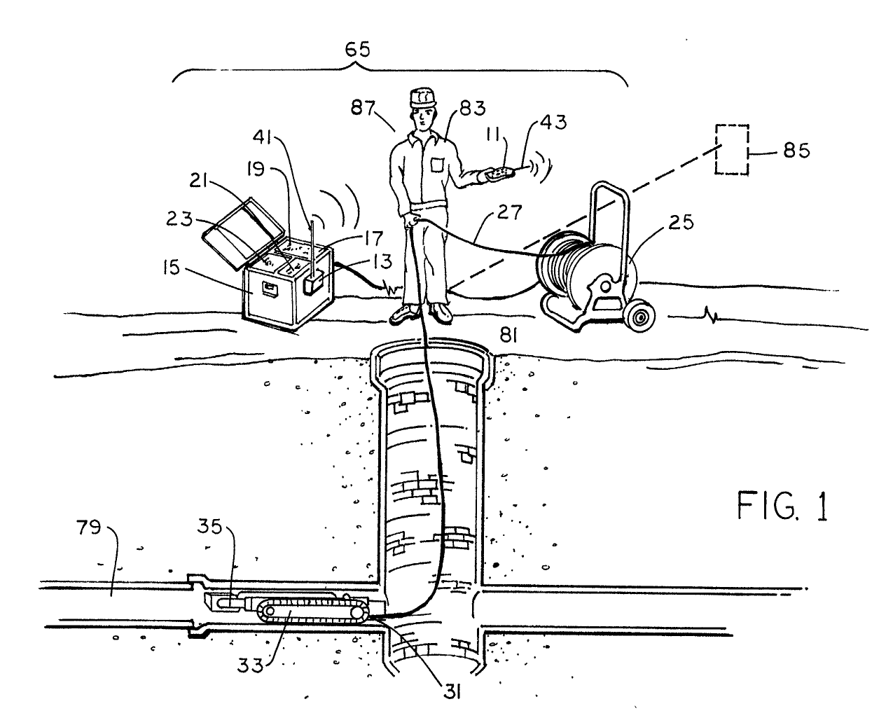

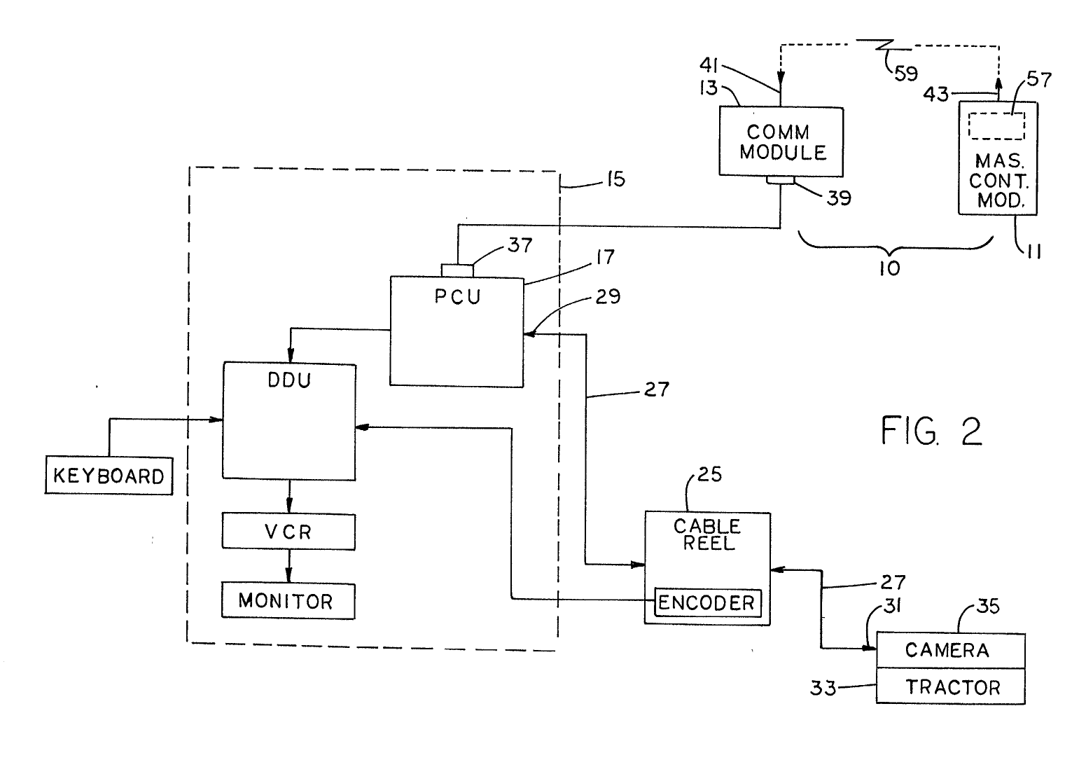

In understanding the invention, it will be helpful to first have an understanding of ways in which pipeline televising systems may be configured and how they are used. Referring first to FIGS. 1 and 2, an aspect of the invention involves apparatus 10 comprising a master control module 11 (which might also be termed a wireless handheld remote controller) and a communication module 13. The pipeline televising equipment includes a field case 15 in which is mounted a power control unit 17, a digital display unit 19, a video cassette recorder (VCR) 21 and a television monitor 23. A reel 25 holds multi-conductor electrical cable 27, the ends 29, 31 of which are coupled to the power control unit 17 and to the tractor 33 and camera 35 used for pipeline televising.

The power control unit 17 has at an input plug 37 while the communication module 13 has an output plug 39 substantially identical to the input plug 37 so that “plug compatibility” is achieved as to number and locations of plug pins. The communication module 13 has an antenna 41 for receiving electromagnetic radiation (EMR) at a radio frequency. A frequency between about 10 KHz and about 6 GHz could be used. However, it is preferred that such frequency be selected to fall within one of the several “license-free” bands. Such bands, described in more detail below, are so named because so long as the transmitter power is kept below a certain level, no U.S. Federal Communication Commission (FCC) license is needed for its operation.

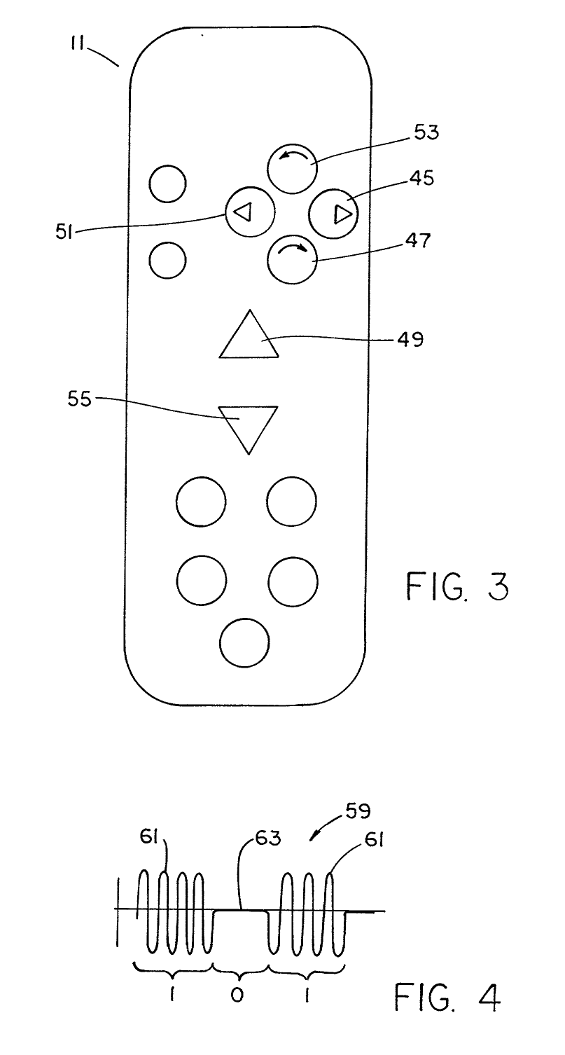

The master control module 11 has a transmitting antenna 43 which radiates the EMR received by the communication module antenna 41. Referring also to FIG. 3, the master control module 11 has at least two actuators 45, 47 (i.e., first and second actuators—push buttons, “bat handle” actuators or the like), one each for panning and for tilting the pipeline television camera 35. In a more specific embodiment, the master control module 11 also has a third actuator 49 for energizing the tractor 33 carrying the camera 35. The exemplary module embodiment shown in FIG. 3 has button-type actuators 45, 51 for controlling camera panning speed, actuators 47, 53 for controlling camera tilt in either of two directions and actuators 49 55 for controlling the tractor forward and reverse, respectively.

The master control module 11 includes a radio-frequency (RF) transmitter 57 coupled to the transmitting antenna 43. When any one of the actuators 45, 47, 49, 51, 53, 55, is manipulated, the transmitting antenna 43 radiates a signal (represented by the symbol 59) having, in preferred embodiments, a frequency in one of the license-free bands. More preferably, such frequency is between about 400 MHz and about 430 MHz and in a very specific embodiment, such frequency is 418 MHz. (It is to be appreciated that selection of transmitting and receiving frequency within a license-free band may primarily be a function of size and cost.)

Referring also to FIG. 4, most preferably, the transmitted signal 59 is known as an on-off keyed (OOK) signal. An on-off keyed transmitter does not transmit a continuous carrier. In an OOK signal, the presence of a transmitted frequency, indicated at 61, is interpreted as a binary “1” while the absence of a transmitted frequency indicated at 63, (when the transmitter is off) is interpreted as a binary “0.”Therefore, the module 1 can transmit digit control module is battery powered, battery life is thereby materially extended. Of course, other types of keying (e.g., frequency shift keying —FSK) could be used but at the expense of shortened battery life or a substantially heavier master control module.

In addition to the communication module 13 and the master control module 11, a highly preferred apparatus 10 also includes the televising camera 35. Thus, the modules 11, 13 and the camera 35 can be sold as a “package” to retrofit existing systems to a wireless remote configuration.

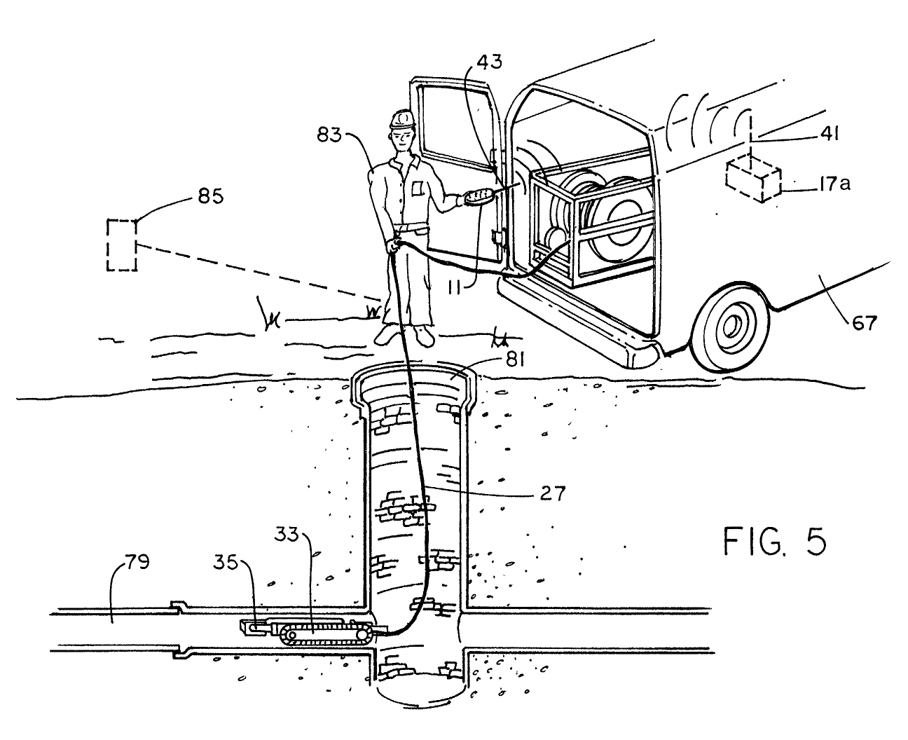

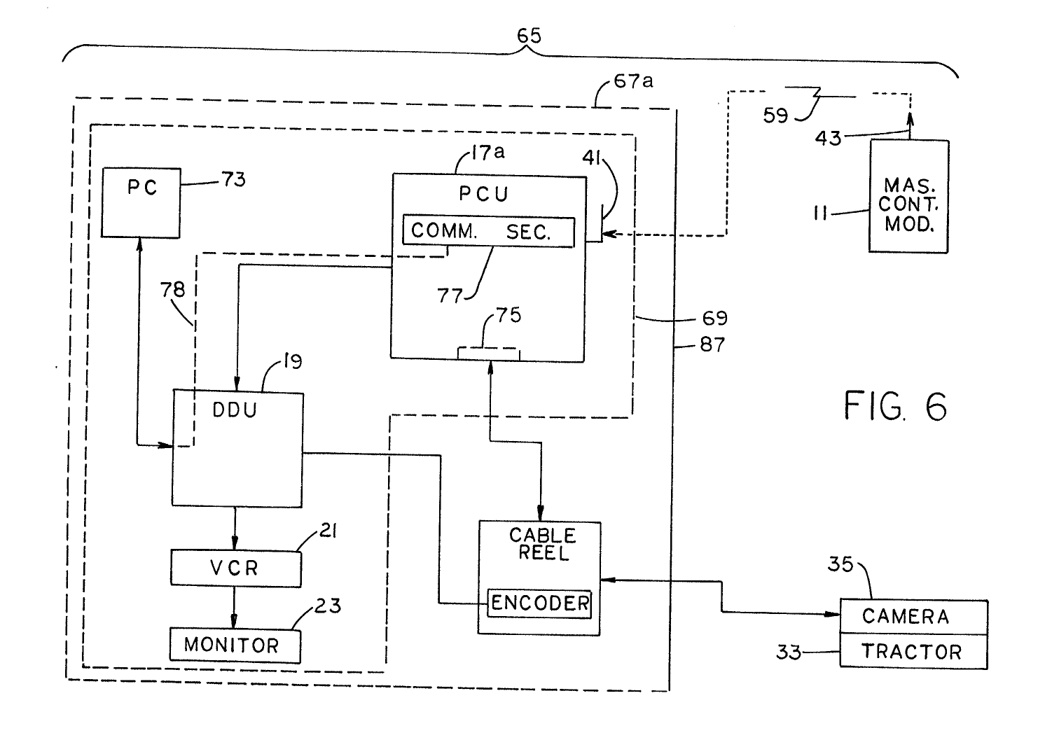

Referring also to FIGS. 5 and 6, another aspect of the invention involves a substantially complete pipeline televising system 65 that might be purchased by a municipality or contractor undertaking to perform pipeline televising. Such system 65, which may be transported from site to site in the truck 67 (represented by the symbol 67a in FIG.6), includes a power control module 69 having (a) a power control unit 17a, (b) a digital display unit 19, (c) a video cassette recorder 21, (d) a television monitor 23, and (e) a personal computer (PC) 73. That is, the power control module 69 is “integrated” (perhaps within a single housing) to include the aforementioned components. A pipeline televising camera 35 is cable-tethered to the power control unit 17a through a power line modem 75.

The power control module 69 also includes a communication section 77 having a receiving antenna 41. And the system 65 has a master control module 11 equipped with a transmitting antenna 43. In this and other respects, a preferred module 11 is like that described above and shown in FIGS. 1 and 3. (It is to be appreciated that the dashed line 78 in FIG. 6 denotes that the PC 73 can communicate with the communication section 77 through the digital display unit 19.)

Yet another aspect of the invention involves a method for televising the interior of a pipeline. Referring to the FIGS. 1-6, such method includes the steps of providing a pipeline televising system 65 having (a) a tractor-mounted camera 35, (b) a power control unit 17 or 17 a cable-coupled to the camera 35, and (c) a communication module 13 (or communication section 77, as the case may be) electrically coupled to the power control unit 17 or 17a and having a receiving antenna 41 mounted thereon. The tractor-mounted camera 35 is lowered and maneuvered into the pipeline to be inspected and televised. Then at least one actuator e.g., actuator 49, on a master control module 11 is manipulated, causing an RF signal (symbol 59) to be transmitted from the master control module 11 to the communication module 13 or section 77. To advance the tractor-mounted camera 35 into such pipeline 79, the actuator 49 is manipulated to cause the tractor to travel forward.

In more specific aspects of the new method, the pipeline 79 includes a manhole 81 and the lowering step includes lowering the tractor-mounted camera 35 downwardly through the manhole 81. The manipulating step is carried out adjacent to the manhole 81. That is, the operator 83 can stand very near the manhole 81 (as shown in FIGS. 1 and 5 ) and lower the camera 35 thereinto while keeping it in view and, simultaneously, controlling the tractor 33 and/or camera 35, all from that vantage point. In a very specific method, the lowering and manipulating steps are carried out within 10 feet of the manhole 81.

Another aspect of the new method relates to an automatic tractor shutoff feature. It is assumed that the manipulating step commands the tractor 33 to move forward inside the pipeline 79. It is also assumed that during the course of work, the operator 83 moves the master control module 11 to a location 85 greater than a predetermined distance (e.g., 100 feet) from the communication module 13 or section 77. (The location symbols 85 in FIGS. 1 and 5 are intended to represent such a position.) When such movement occurs, the tractor 33 is disabled. The communication module 13 or section 77 is arranged in such a way that its internal circuitry periodically (every few milliseconds) “checks” to see whether a signal is still being received from the master control module 11. When the module 11 gets “out of range” of module 13 or section 77, the RF signal becomes so weak that the communication module or section interprets it as a lost signal. Tractor disabling follows. (It is to be appreciated that the maximum output power of the master control module is only a few milliwatts.)

Yet another aspect of the new method assumes there is an opaque barrier 87 (e.g., the operator 83 or the truck 67 or 67a used to transport the system 65 from site to site) between the master control module 11 and the communication module 13 or section 77. The transmitting step includes transmitting the RF signal 59 through the barrier 87. (Two aspects of the foregoing are to be appreciated. One is that the pipeline televising equipment shown in FIGS. 1 and 2 can be sold as a complete system and need not involve a retrofit to existing components. Another is that the system shown in FIGS. 5 and 6 can also be sold as a complete system or can involve retrofit of a master control module 11 and a communication module 13 to an existing set of equipment.)

As used herein, the term “wireless” when referring to communication from a master control module 11 to a communication module 13 or section 77 means that such communication is carried out free of electrical wires between such module 13 and a module 13 or section 77. The term “communication section 77” means a component which is built into a power control module 69. The term “communication module 69” means a self-contained (usually in its own case) component coupled to a power control unit 17, 17a often by field retrofit.

The term “license-free band” means any band of frequencies, transmission of signals within which does not require a license from the U.S. Federal Communication Commission so long as the regulatory maximum power level(s) are observed. Currently, such license-free bands include 49-55 MHz, 72-76 MHz, 170-216MHz, 260-470 MHz,890-940 MHz, 2.43-2.49 GHZ and 5.72-5.85 GHz Currently, such license-free bands are defined in 47 Code of Federal Regulations (CFR) Part 15.

While the principles of the invention have been shown and described in connection with preferred embodiments, it is to be understood clearly that such embodiments are by way of example and are not limiting.

What is claimed:

1. Apparatus for controlling pipeline televising equipment comprising a power control unit having at least one input plug, the apparatus including:
a communication module having an output plug substantially identical to the input plug, such module including a receiving antenna; and
a wireless master control module including a transmitting antenna;
and wherein:
the control module includes at least two actuators, one each for panning and for tilting a pipeline television camera.

2. The apparatus of claim 1 wherein the actuators are first and second actuators and the control module includes a third actuator for energizing a tractor carrying the camera.

3. The apparatus of claim 2 wherein:
the master control module includes a radio-frequency transmitter coupled to the transmitting antenna; and
when the first actuator is manipulated, the transmitting antenna radiates a signal having a frequency between about 10 KHz and about 6 GHz.

4. The apparatus of claim 3 wherein:
when either one of the second and third actuators is manipulated, the transmitting antenna radiates a signal having a frequency between about 10 KHz and about 6 GHz.

5. The apparatus of claim 4 wherein the transmitting antenna radiates a signal having a frequency between about 400 MHz and 430 Mhz.

6. The apparatus of claim 4 wherein the signal is an on-off keyed signal.

7. The apparatus of claim 1 further including the pipeline televising camera.

8. In a pipeline televising system including:
a power control module having (a) a power control unit, (b) a digital display unit, (c) a video cassette recorder, and (d) a television monitor; and
a pipeline televising camera cable-tethered to the power control unit through a power line modem;
the improvement wherein:
the power control module includes a communication section having a receiving antenna; and
the system includes a master control module having a transmitting antenna.

9. The system of claim 8 wherein:
the master control module includes an actuator for panning the camera; and
when the actuator is manipulated, a radio frequency signal radiates from the transmitting antenna and is received by the receiving antenna.

10. The system of claim 9 wherein:
the transmitting and receiving antennae are separated by an opaque barrier; and
when the radio frequency signal propagates from the transmitting antenna, such signal penetrates the barrier.

11. The system of claim 10 wherein:
the transmitting antenna radiates a signal; and
the signal has a frequency between about 400 MHz and about 430 MHz.

12. A method for televising the interior of a pipeline including the steps of:
providing a pipeline televising system having (a) a tractor-mounted television camera, (b) a power control unit cable-coupled to the camera, and (c) a communication module cable-coupled to the power control unit and having a receiving antenna mounted thereon;
moving the tractor-mounted camera into a pipeline;
manipulating at least one actuator on a master control module having a transmitting antenna; and,
transmitting a radio frequency signal from the master control module to the communication module.

13. The method of claim 12 wherein:
the pipeline includes a manhole;
the moving step includes lowering the tractor-mounted camera through the manhole; and
the manipulating step is carried out adjacent to the manhole.

14. The method of claim 13 wherein the lowering and manipulating steps are carried out within 10 feet of the manhole.

15. The method of claim 14 wherein the system has an operator and the manipulating step is carried out by the operator while viewing the tractor-mounted camera.

16. The method of claim 12 wherein the manipulating step commands the tractor to move forward inside the pipeline and the method further includes the steps of:
moving the master control module to a location which is greater than a predetermined distance from the communication module; and
disabling the tractor.

17. The method of claim 12 wherein the pipeline televising system includes an opaque barrier between the transmitting and receiving antennas and the transmitting step includes transmitting the radio frequency signal through the barrier.

18. The method of claim 12 wherein the radio frequency signal is an on-off keyed signal.

19. The method of claim 17 wherein the radio frequency signal is an on-off keyed signal.
